(19) United States
(12) Patent Application Publication
(10) Pub. No.: US 2013/0010119 A1
(43) Pub. Date: Jan. 10, 2013

(54) PARKING ASSISTANCE APPARATUS, PARKING ASSISTANCE SYSTEM, AND PARKING ASSISTANCE CAMERA UNIT

(75) Inventor: Tatsuya Mitsugi, Tokyo (JP)

(73) Assignee: MITSUBISHI ELECTRIC CORPORATION, Tokyo (JP)

(21) Appl. No.: 13/638,273

(22) PCT Filed: May 14, 2010
(86) PCT No.: PCT/JP2010/003274

§ 371 Date: Sep. 28, 2012

(51) Int. Cl. H04N 7/18

(52) U.S. Cl. 348/148; 348/E07.085

(57) ABSTRACT

An object is to provide a parking assistance apparatus capable of readily generating a guide line image showing guide lines used as targets when a vehicle is parked.

On the basis of guide line interval information on intervals among guide lines and attachment information indicating attachment position and angle of a camera with respect to a vehicle, the parking assistance apparatus generates guide line information on positions of the guide lines set on the parking plane in a camera image and displays an image in which the guide lines are set on the parking plane on the basis of a guide line image generated from the guide line information and a camera image.

### TECHNICAL FIELD

The present invention relates to a parking assistance apparatus that assists a driver when he parks a vehicle to move and park the vehicle in a parking stall behind the vehicle by enabling the driver to visually confirm an environment behind the vehicle.

### BACKGROUND ART

A parking assistance apparatus captures an image of a parking plane behind a vehicle using a camera attached to the vehicle and, on the basis of the captured camera image, displays an image in which guide lines serving as guide to a parking position when a driver of the vehicle parks the vehicle are set on the parking plane. Such a display is achieved by displaying an overlay of a guide line image showing the guide lines on the camera image. In the related art, the guide line image is preliminarily generated by capturing an image of a parking plane with a camera of a vehicle parked in a predetermined reference state with respect to the parking plane and setting guide lines to the captured reference camera image. The parking assistance apparatus assists the driver in parking the vehicle by displaying an overlay of the preliminarily generated guide line image on the camera image. However, even with the guide line image generated in this manner, the parking assistance apparatus fails to display the guide lines at appropriate positions in a case where an attachment error occurs when the camera is actually attached to the vehicle. To overcome this inconvenience, there is an apparatus configured to correct the attachment error using the guide line image (Patent Document 1).

### CITED LIST

### Patent Document

Patent Document 1: JP-A-2007-158695

### SUMMARY OF THE INVENTION

### Problems that the Invention is to Solve

However, in order to capture the reference camera image, it is necessary to park a vehicle exactly in the reference state first and then attach the camera precisely at a predetermined attachment position and at a predetermined angle both of which are determined for vehicles type by type. In addition, because a camera image is distorted to capture an image in a wide range, the guide line image is drawn manually to match the guide line image to a distortion of the camera image. Accordingly, it takes a time to generate the guide line image and this generation work becomes a burden on manufactures of the parking assistance apparatus.

Under these circumstances, the invention has an object to provide a parking assistance apparatus capable of readily generating a guide line image.

### Means for Solving the Problems

A parking assistance apparatus of the invention is a parking assistance apparatus connected to a camera that is attached to a vehicle and captures an image of a parking plane behind the vehicle and displaying, on a display apparatus, an image in which guide lines used as a target when the vehicle is parked are set on the parking plane on the basis of a camera image captured by the camera. The parking assistance apparatus includes: an information storage portion that stores guide line interval information on intervals among the guide lines and attachment information indicating attachment position and angle of the camera with respect to the vehicle; a guide line information generation portion that generates guide line information on positions of the guide lines set on the parking plane in the camera image on the basis of the guide line interval information and the attachment information; a guide line image generation portion that generates a guide line image representing the guide lines on the basis of the guide line information; and an image output portion that outputs, to the display apparatus, an image in which the guide lines are set on the parking plane on the basis of the guide line image and the camera image.

### Advantage of the Invention

According to the invention, it becomes possible to readily generate a guide line image.

### BRIEF DESCRIPTION OF THE DRAWINGS

FIG. 1 is a block diagram showing a configuration of a parking assistance system of a first embodiment.

FIG. 2 is a block diagram showing a configuration of a guide line calculation portion of the parking assistance system of the first embodiment.

FIG. 3 shows an example of guide lines on an actual space calculated in a guide line generation portion of the parking assistance system of the first embodiment.

FIG. 4 is a block diagram showing a configuration of a camera image correction portion of the parking assistance system of the first embodiment.

FIG. 5 shows an example of a guide line image displayed under a first display condition in the parking assistance system of the first embodiment.

FIG. 6 shows an example of a guide line image displayed under a second display condition in the parking assistance system of the first embodiment.

FIG. 7 shows an example of a guide line image displayed under a third display condition in the parking assistance system of the first embodiment.

FIG. 8 is a block diagram showing a configuration of a parking assistance system of a second embodiment.

FIG. 9 is a block diagram showing a configuration of a parking assistance system of a third embodiment.

FIG. 10 is a block diagram showing a configuration of a parking assistance system of a fourth embodiment.

FIG. 11 is a block diagram showing a configuration of a parking assistance system of a fifth embodiment.

FIG. 12 is a block diagram showing a configuration of a parking assistance system of a sixth embodiment.

FIG. 13 is a block diagram showing a configuration of a parking assistance system of a seventh embodiment.

### MODE FOR CARRYING OUT THE INVENTION

### First Embodiment

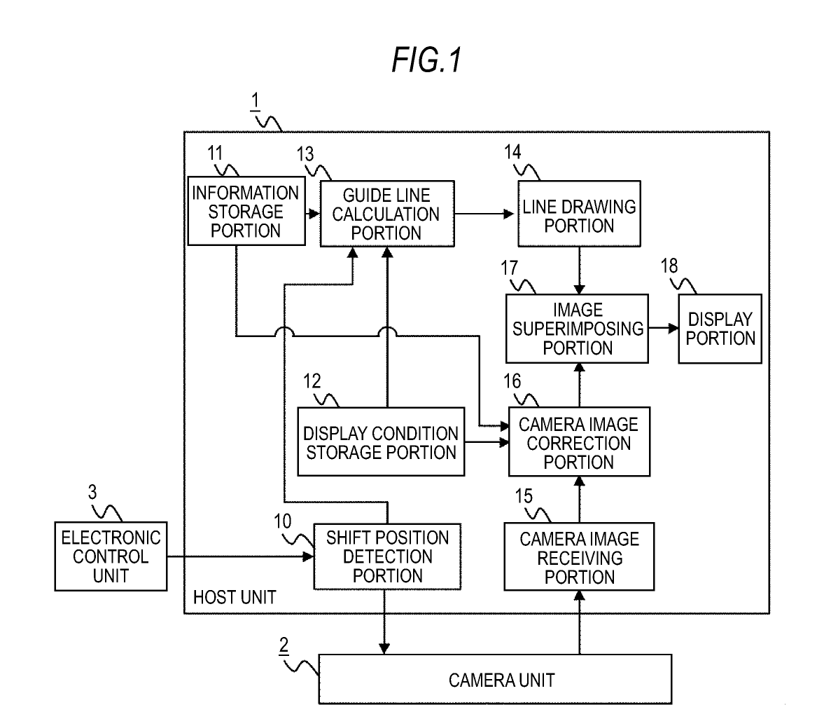

FIG. 1 is a block diagram showing a configuration of a parking assistance system of a first embodiment. Referring to FIG. 1, the parking assist system includes a host unit 1 that is a parking assistance apparatus and a camera unit 2 connected to the host unit 1. An electronic control unit 3 is an ECU (Electric Control Unit) generally installed to a vehicle to control electronic components of the vehicle using an electronic circuit and serves as a vehicle information output apparatus that detects vehicle information and outputs the vehicle information to the host unit 1. In particular, the vehicle information output apparatus of this embodiment serves as a shift position information output apparatus and outputs, to the host unit 1, shift position information indicating a state of a transmission of a vehicle which varies in response to an operation by a driver. Car navigation apparatuses showing a route to a destination are often installed to automobiles. There are car navigation apparatuses pre-installed to vehicles and car navigation apparatuses sold separately from vehicles and attached to the vehicles later. For commercially available car navigation apparatuses to be attached to vehicles, the ECU is provided with a terminal from which the shift position information is outputted. Hence, in the parking assistance system of this embodiment, it becomes possible to acquire the shift position information by connecting the host unit 1 to this output terminal. The host unit 1 may be provided integrally with the car navigation apparatus or in the form of a separate apparatus.

The host unit 1 includes a shift position detection portion 10 that detects a state of the transmission of the vehicle on the basis of the shift position information outputted from the electronic control unit 3, an information storage portion 11 that has stored information used to calculate guide lines described below, a display condition storage portion 12 that stores display condition information on the basis of which to determine in which manner a guide line image described below and a camera image are displayed on a display portion 18, a guide line calculation portion 13 (guide line information generation portion) that calculates guide line information that is information on drawing positions of guide lines when displayed on the display portion 18 described below, that is, positions and shapes of the guide lines in a camera image captured by the camera, on the basis of the information stored in the information storage portion 11 and the display condition information stored in the display condition storage portion 12, a line drawing portion 14 (guide line image generation portion) that generates a guide line image in which the guide lines are drawn on the basis of the guide line information calculated in the guide line calculation portion 13, a camera image receiving portion 15 that receives a camera image transmitted from the camera unit 2, a camera image correction portion 16 that corrects the camera image received in the camera image receiving portion 15 on the basis of the information stored in the information storage portion 11 and the display condition information stored in the display condition storage portion 12, an image superimposing portion 17 that sets the guide line image outputted from the line drawing portion 14 and a corrected camera image outputted from the camera image correction portion 16 to images in different layers and thereby superimposes the guide line image and the corrected camera image, and the display portion 18 (for example, an in-vehicle monitor) that combines the guide line image and the corrected camera image in different layers outputted from the image superimposing portion 17 into one image and displays the resulting composite image thereon. The camera unit 2 has a camera (not shown) as an imaging portion that captures an image of an environment around (particularly, behind) the vehicle, and transmits a camera image captured by the camera to the host unit 1 upon input of the shift position information informing that the transmission of the vehicle is in a reverse (backward) state from the shift position detection portion 10 in the host unit 1. The camera image correction portion 16 and the image superimposing portion 17 together form an image output portion. Owing to the configuration as above, an image in which the guide line image generated in the line drawing portion 14 is superimposed on the camera image transmitted from the camera unit 2 is displayed on the display portion 18. Hence, by confirming this image, the driver of the vehicle becomes able to park the vehicle using the guide lines as a target while visually confirming the environments behind and around the vehicle he is driving. Hereinafter, respective components forming the parking assistance system will be described in detail.

Referring to FIG. 1, the information storage portion 11 pre-stores guide line calculation information used to calculate the guide lines described below, more specifically, attachment information, field angle information, projection information, point-of-view information, lens distortion information, parking width information, vehicle width information, distance information on a safe distance, a caution distance, and a warning distance from a rear end of the vehicle. The attachment information is information indicating in which manner the camera is attached to the vehicle, that is, an attachment position and an attachment angle. The field angle information is angle information indicating a range of a subject captured by the camera of the camera unit 2 and also display information indicating a display range when an image is displayed on the display portion 18. The angle information includes a maximum horizontal field angle Xa and a maximum vertical field angle Ya or a diagonal field angle of the camera. The display information includes a maximum horizontal drawing pixel size Xp and a maximum vertical drawing pixel size Yp of the display portion 18. The projection information is information indicating a projection method of a lens used in the camera of the camera unit 2. In this embodiment, a fish-eye lens is used as the lens of the camera. Hence, any one of stereographic projection, equidistance projection, equisolidangle projection, and orthogonal projection is used as a value of the projection information. The point-of-view information is information on a different position at which the camera is assumed to be present. The lens distortion information is information on properties of the lens relating to an image distortion caused by the lens. The projection information, the lens distortion information, and the point-of-view information together form camera correction information described below. The parking width information is information indicating a parking width (for example, a width of a parking stall) found by adding a predetermined margin of width to a width of the vehicle. The distance information on a safe distance, a caution distance, and a warning distance from the rear end of the vehicle indicates a distance to the rear from the rear end of the vehicle and indicates an approximate distance to the rear of the vehicle set, for example, as follows: the safe distance is 1 m from the rear end of the vehicle, the caution distance is 50 cm, and the warning distance is 10 cm. The driver becomes able to understand an approximate distance from the rear end of the vehicle to an obstacle displayed behind the vehicle in reference to the guide lines drawn at the safe distance, the caution distance, and the warning distance from the rear end of the vehicle. It should be noted that the parking width information, the vehicle width information, and the distance information on the safe distance, the caution distance, and the warning distance from the rear end of the vehicle are guide line interval information on intervals among the guide lines set and drawn in the guide line image.

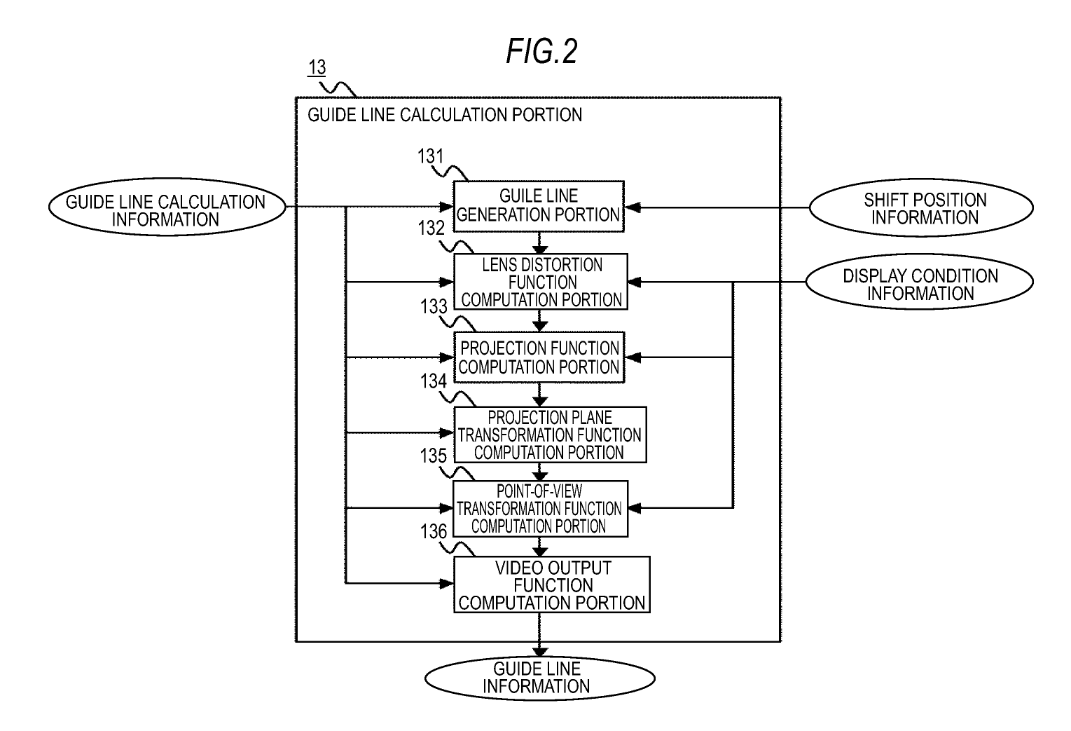

FIG. 2 is a block diagram showing a configuration of the guide line calculation portion 13. The guide line calculation portion 13 includes a guide line generation portion 131, a lens distortion function computation portion 132, a projection function computation portion 133, a projection plane transformation function computation portion 134, a point-of-view transformation function computation portion 135, and a video output transformation function computation portion 136. The lens distortion function computation portion 132, the projection function computation portion 133, and the point-of-view transformation function computation portion 135 are not operated in some cases depending on the display condition information. Accordingly, for ease of understanding, a description will be given first to a case where all of these components operate.

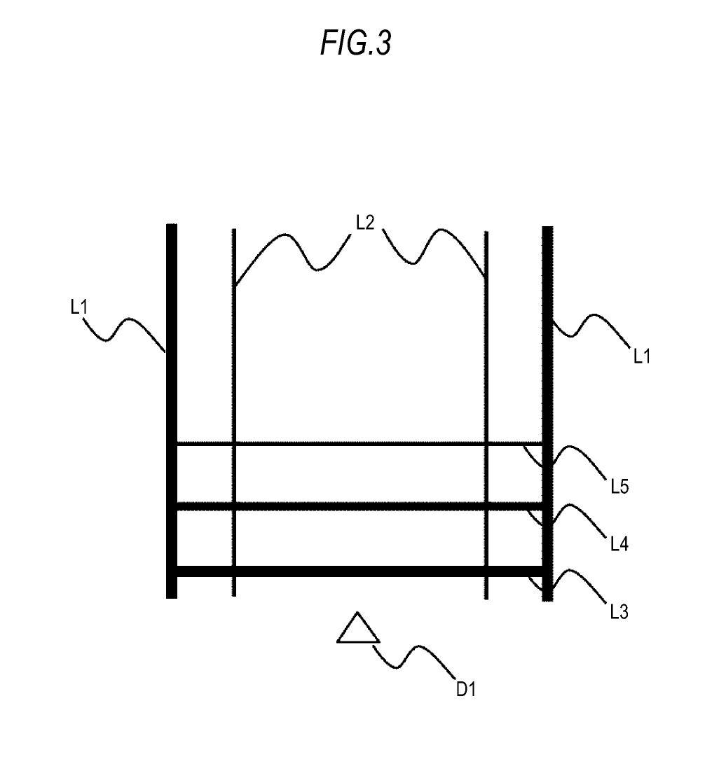

The guide line generation portion 131 virtually sets guide lines on the parking plane that is a plane at a position behind the vehicle at which the vehicle is to be parked on the basis of the parking width information and the vehicle width information acquired from the information storage portion 11 upon input of the shift position information informing that the transmission of the vehicle is in a reverse (backward) state from the shift position detection portion 10. FIG. 3 shows an example of the guide lines on an actual space that are calculated in the guide line generation portion 131. In FIG. 3, lines L1 are guide lines indicating a width of a parking stall, lines L2 are guide lines indicating a width of the vehicle, and lines L3 through L5 are guide lines indicating distances from the rear end of the vehicle. The line L3 indicates the warning distance, the line L4 indicates the caution distance, and the line L5 indicates the safe distance. The lines L1 and L2 start from a side closer to the vehicle than the line L3 closest to the vehicle and have a length at least as long as about a length of the parking stall on a side farther from the vehicle. The lines L3 through L5 are drawn to link the lines L2 on the both sides. A direction D1 indicates a direction in which the vehicle comes into the parking stall. Both of the guide lines indicating the vehicle width and the parking width are displayed herein. It should be appreciated, however, that the guide lines indicating only one of the vehicle width and the parking width may be displayed. Also, the guide lines indicating a distance from the rear end of the vehicle may be two or less or four or more lines. For example, a guide line may be displayed at a distance as long as a length of the vehicle from any one of the lines L3 through L5. Alternatively, either the guide lines parallel to a moving direction of the vehicle (L1 and L2 in FIG. 3) or the guide lines indicating a distance from the rear end of the vehicle alone may be displayed. A display form (color, thickness, types of line) of the guide lines parallel to the moving direction of the vehicle may be varied with a distance from the rear end of the vehicle or a mark indicating a predetermined distance from the rear end of the vehicle may be put on these guide lines. A length of the guide lines indicating a distance from the rear end of the vehicle may be equal to the parking width or the vehicle width, or any other length. In a case where these guide lines are displayed in a length as long as or longer than the parking width, these guide lines may be displayed so that a portion corresponding to either one or both of the vehicle width and the parking width can be discriminated.

The guide line generation portion 131 finds and outputs coordinates of a start point and an end point of each guide line shown in FIG. 3. The respective function computation portions in the latter stage compute a value of a coordinate that gives influences same as influences given when an image of the guide lines is captured by the camera for necessary points on the respective guide lines. On the basis of the guide line information as a result of the computations, a guide line image is generated in the line drawing portion 14. An image in which the guide line image is superimposed on the camera image without any displacement is displayed on the display portion 18. Hereinafter, for ease of description, a description will be given to a single coordinate P=(x, y) on the guide lines virtually set on the parking plane behind the vehicle shown in FIG. 3 by way of example. The coordinate P can be defined, for example, as a position on orthogonal coordinates whose origin is at a point on the parking plane behind the vehicle at a predetermined distance from the vehicle.

The lens distortion function computation portion 132 computes a lens distortion function i( ) determined on the basis of the lens distortion information acquired from the information storage portion 11 for the coordinate P indicating the guide line calculated in the guide line generation portion 131 and thereby transforms the coordinate P to a coordinate i(P) that has undergone a lens distortion. The lens distortion function i( ) is a function expressing a distortion that the camera image undergoes due to a lens shape when an image of a subject is captured by the camera of the camera unit 2. The lens distortion function i( ) can be found, for example, from a Zhang model relating to a lens distortion. In a Zhang model, a lens distortion is modeled by a radial distortion and a calculation as follows is carried out.

Let (u, v) be a normalized coordinate unaffected by a lens distortion and (um, vm) be a normalized coordinate affected by a lens distortion. Then, a relation as follows is established:

um=u+u*(k1*r²+k2*r⁴)

vm=v+v*(k1*r²+k2*r⁴)

r²=u²+v²

where k1 and k2 are coefficients when a lens distortion in the form of a radial distortion is expressed by a polynomial expression and each is a constant unique to the lens.

The coordinate P=(x, y) and the coordinate i(P)=(xm, ym) that has undergone a lens distortion have a relation expressed as follows:

xm=x+(x−x₀)*(k1*r²+k2*r⁴)

ym=y+(y−y₀)*(k1*r²+k2*r⁴)

r²=(x−x₀)²+(y−y₀)²

where (x₀, y₀) is a point on the parking plane corresponding to a main point that is a center of the radial distortion at the coordinate unaffected by a lens distortion. Herein, (x₀, y₀) is found preliminarily from the attachment information of the camera unit 2. For the lens distortion function computation portion 132 and the projection function computation portion 133, assume that an optical axis of the lens is perpendicular to the parking plane and passes through (x₀, y₀) described above.

The projection function computation portion 133 computes a function h( ) by a projection method determined on the basis of the projection information acquired from the information storage portion 11 for the coordinate i(P) that is outputted from the lens distortion function computation portion 132 and therefore has undergone a lens distortion, thereby transforming the coordinate i(P) to a coordinate h(i(P)) affected by the projection method (hereinafter, referred to as having undergone a projection distortion). The function h( ) by the projection method is a function expressing how far from a center of the lens light incident on the lens at an angle of θ converges. With the function h( ) by the projection method, let f be a focal distance of the lens, θ be an incident angle of incident light, that is, a half field angle, and Y be an image height (a distance between the center of the lens and the light-converging position) in an imaging area of the camera, then the image height Y is computed for each projection method using any one of the following equations:

stereographic projection Y=2*f*tan(θ/2)

equidistance projection Y=f*θ

equisolidangle projection Y=2*f*sin(θ/2)

orthogonal projection Y=f*sin θ.

The projection function computation portion 133 computes the coordinate h(i(P)) that has undergone a projection distortion by transforming the coordinate i(P) that is outputted from the lens distortion function computation portion 132 and therefore has undergone a lens distortion to the incident angle θ with respect to the lens, calculating the image height Y by substituting the incident angle θ into any one of the projection equations above, and by returning the image height Y to the coordinate.

The projection plane transformation function computation portion 134 further computes a projection plane transformation function f( ) determined on the basis of the attachment information acquired from the information storage portion 11 for the coordinate h(i(P)) that is outputted from the projection function computation portion 133 and therefore has undergone a projection distortion, thereby transforming the coordinate h(i(P)) to a coordinate f(h(i(P))) that has undergone the projection plane transformation. The projection plane transformation is a transformation to add influences of an attachment state on the ground that an image captured by the camera is affected by the attachment state, such as the attachment position and angle of the camera. By this transformation, the respective coordinates representing the guide lines are transformed to coordinates as if captured by the camera attached to the vehicle at the position specified by the attachment information. The attachment information used for the projection plane transformation function f( ) includes a height L of the attachment position of the camera with respect to the parking plane, an attachment vertical angle φ that is an angle of inclination of the optical axis of the camera with respect to a vertical line, an attachment horizontal angle θ that is an angle of inclination with respect to a center line running longitudinally from front to rear of the vehicle, and a distance H from a center of the vehicle width. The projection plane transformation function f( ) is expressed by a geometric function using these parameters. Herein, assume that the camera is attached properly without causing displacement in a direction of tilt rotation using the optical axis as the axis of rotation.

The point-of-view transformation function computation portion 135 further computes a point-of-view transformation function j( ) determined on the basis of the point-of-view information acquired from the information storage portion 11 for the coordinate f(h(i(P))) that is outputted from the projection plane transformation function computation portion 134 and therefore has undergone the projection plane transformation, thereby transforming the coordinate f(h(i(P))) to a coordinate j(f(h(i(P)))) that has undergone the point-of-view transformation. An image obtained when a subject is captured by a camera is an image of the subject viewed from the position at which the camera is attached. The point-of-view transformation transforms this image to an image as if captured by a camera present at a different position (for example, a camera virtually set at a predetermined height position in the parking plane behind the vehicle so as to face the parking plane), that is, an image from a different point of view. The point-of-view transformation can be achieved by adding a transformation of a type called affine transformation to an original image. The affine transformation is a coordinate transformation as a combination of parallel translation and linear mapping. Parallel translation by the affine transformation corresponds to moving the camera from the attachment position specified by the attachment information to the different position. Linear mapping corresponds to rotating the camera from the direction specified by the camera attachment information so as to agree with the orientation of the camera assumed to be present at the different position. It should be noted that the image transformation used in the point-of-view transformation is not limited to the affine transformation and other types of transformation can be used as well.

The video output function computation portion 136 further computes a video output function g( ) determined on the basis of the field angle information acquired from the information storage portion 11 for the coordinate j(f(h(i(P)))) that has undergone the point-of-view transformation and thereby transforms the coordinate j(f(h(i(P)))) to a video output coordinate g(j(f(h(i(P))))). Because it is general that a size of a camera image captured by the camera is different from a size of an image displayable on the display portion 18, the camera image is changed to a displayable size of the display portion 18. Accordingly, by applying a transformation equivalent to changing of the camera image to a displayable size of the display portion 18 to the coordinate j(f(h(i(P)))) that has undergone the point-of-view transformation in the video output function computation portion 136, the camera image can be changed to scale. The video output transformation function g( ) is expressed by a mapping function using the maximum horizontal field angle Xa and the maximum vertical field angle Ya of the camera and the maximum horizontal drawing pixel size Xp and the maximum vertical drawing pixel size Yp in a video output.

In the description above, the lens distortion function, the projection function, the point-of-view transformation function, the projection plane transformation function, and the video output function are computed in this order for the respective coordinates representing the guide lines. It should be appreciated, however, that the respective functions are not necessarily computed in this order.

The projection plane transformation function f( ) in the projection plane transformation function computation portion 134 includes a camera field angle (the maximum horizontal field angle Xa and the maximum vertical field angle Ya of the camera) as the information indicating a size of the captured camera image. Hence, even in a case where a part of the camera image received in the camera image receiving portion 15 is extracted and displayed, by changing coefficients of the camera field angle in the projection plane transformation function f( ), it becomes possible to display the guide lines so as to match the extracted part of the camera image.

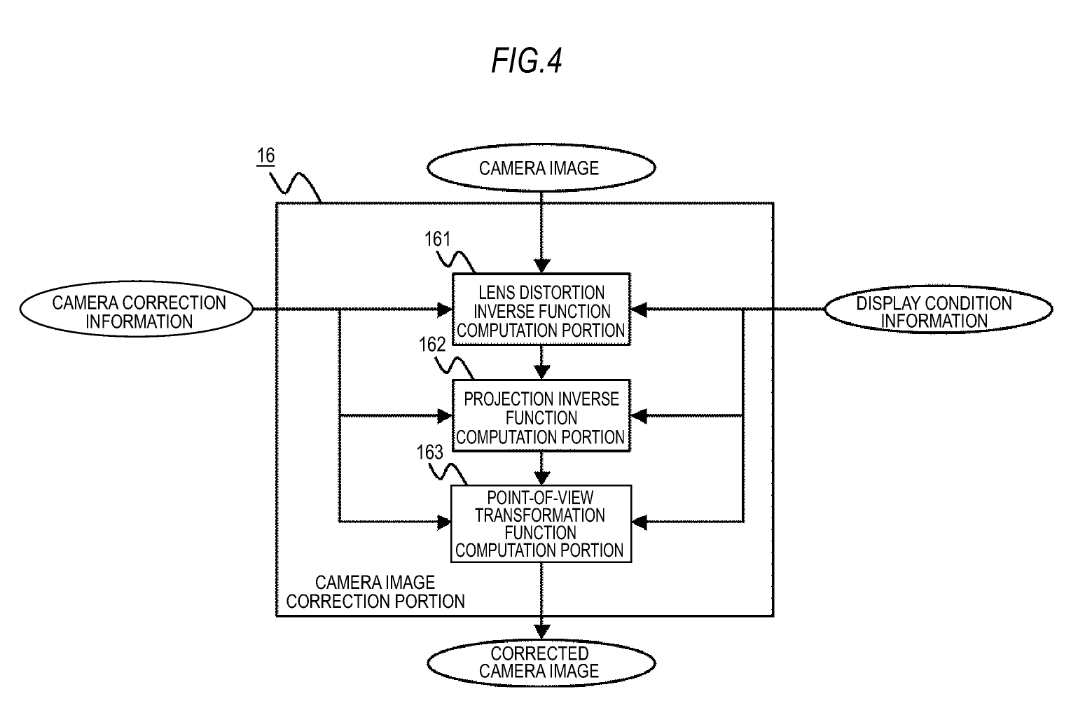

FIG. 4 is a block diagram showing a configuration of the camera image correction portion 16. The camera image correction portion 16 includes a lens distortion inverse function computation portion 161, a projection distortion inverse function computation portion 162, and a point-of-view transformation function computation portion 163. These components are not operated in some cases depending on the display condition information. Accordingly, for ease of understanding, a description will be given first to a case where all of these components operate.

The lens distortion inverse function computation portion 161 finds an inverse function i⁻¹( ) of the lens distortion function i( ) described above on the basis of the lens distortion information contained in the camera correction information and performs a computation for the camera image. The camera image transmitted from the camera unit 2 is affected by a lens distortion when captured by the camera. Hence, by computing the lens distortion inverse function i⁻¹( ), it becomes possible to correct the camera image to be a camera image unaffected by a lens distortion.

The projection inverse function computation portion 162 finds an inverse function h⁻¹( ) of the projection function h( ) described above on the basis of the projection information contained in the camera correction information and performs a computation for the camera image that is outputted from the lens distortion inverse function computation portion 161 and therefore unaffected by a lens distortion. The camera image transmitted from the camera unit 2 has undergone a distortion due to the projection method of the lens when captured by the camera. Hence, by computing the projection inverse function h⁻¹( ), it becomes possible to correct the camera image to be a camera image that has not undergone a projection distortion.

The point-of-view transformation function computation portion 163 applies the point-of-view transformation function j( ) described above to the camera image that is outputted from the projection inverse function computation portion 162 and therefore has not undergone a projection distortion on the basis of the point-of-view information contained in the camera correction information. In this manner, a camera image that has undergone the point-of-view camera transformation can be obtained.

Referring to FIG. 1, for the guide line image computed and drawn in the line drawing portion 14 to be overlaid on the corrected camera image outputted from the camera image correction portion 16, the image superimposing portion 17 superimposes the guide line image and the corrected camera image as images in different layers. Of the guide line image and the corrected camera image indifferent layers, the display portion 18 applies the video output function g( ) to the corrected camera image, so that a size of the corrected camera image is changed to a displayable size of the display portion 18. Then, the guide line image and the corrected camera image of the changed size are combined and displayed. The video output function g( ) may be applied in the camera image correction portion 16.

Operations will now be described. Operations of the guide line calculation portion 13 and the camera image correction portion 16 differ depending on the display condition information acquired with reference to the display condition storage portion 12. The display condition information can be, for example, four display conditions as follows depending on operations of the camera image correction portion 16, that is, differences of display methods of the camera image.

(1) Under a first display condition, the camera image correction portion 16 does not correct the camera image. The guide line calculation portion 13 calculates the guide line information to which the projection plane transformation is applied by adding a lens distortion and a distortion due to the projection method.

(2) Under a second display condition, the camera image correction portion 16 corrects the camera image so as to eliminate a lens distortion and a distortion due to the projection method. The guide line calculation portion 13 calculates the guide line information to which the projection plane transformation alone is applied.

(3) Under a third display condition, the camera image correction portion 16 corrects the camera image as if having undergone the point-of-view transformation. The guide line calculation portion 13 calculates the guide line information to which the projection plane transformation and the point-of-view transformation are applied by adding a lens distortion and a distortion due to the projection method.

(4) Under a fourth display condition, the camera image correction portion 16 corrects the camera image as if having undergone the point-of-view transformation by eliminating a lens distortion and a distortion due to the projection method. The guide line calculation portion 13 calculates the guide line information to which the projection plane transformation and the point-of-view transformation are applied.

Under any of these display conditions, the guide line image is drawn to match the camera image.

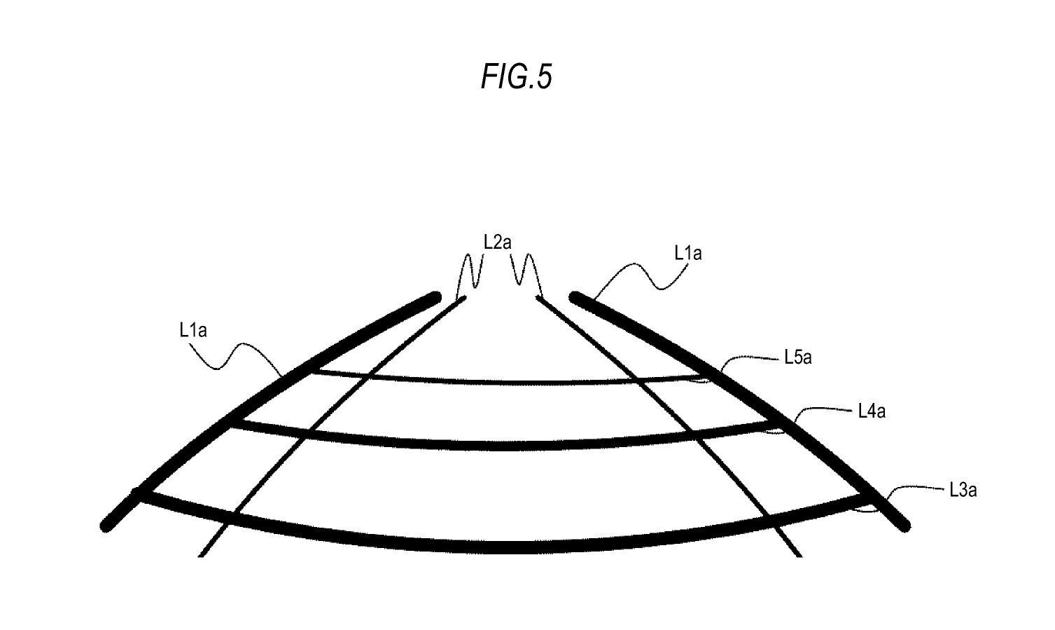

In a case where the display condition information exhibits the first display condition, of the components forming the guide line calculation portion 13 shown in FIG. 2, the components other than the point-of-view transformation function computation portion 135 are operated. More specifically, computation results of the lens distortion function computation portion 132, the projection function computation portion 133, and the projection plane transformation function computation portion 134 are inputted into the video output transformation function computation portion 136. Consequently, the guide line image generated in the line drawing portion 14 is as shown in FIG. 5. FIG. 5 shows an example of the guide line image generated under the first display condition. A camera image having a lens distortion and a distortion due to the projection method and the guide line image to which the same distortions are added are displayed by superimposing the latter on the former. In FIG. 5, lines L1a are guide lines indicating a width of the parking stall and correspond to the line L1 of FIG. 3. Lines L2a are guide lines indicating a width of the vehicle and correspond to the line L2 of FIG. 3. Lines L3a through L5a are guide lines indicating distances from the vehicle and correspond, respectively, to the line L3 through L5 of FIG. 3. Also, not all the components forming the camera image correction portion 16 shown in FIG. 4 are operated. More specifically, the camera image correction portion 16 outputs the camera image inputted therein intact to the image superimposing portion 17.

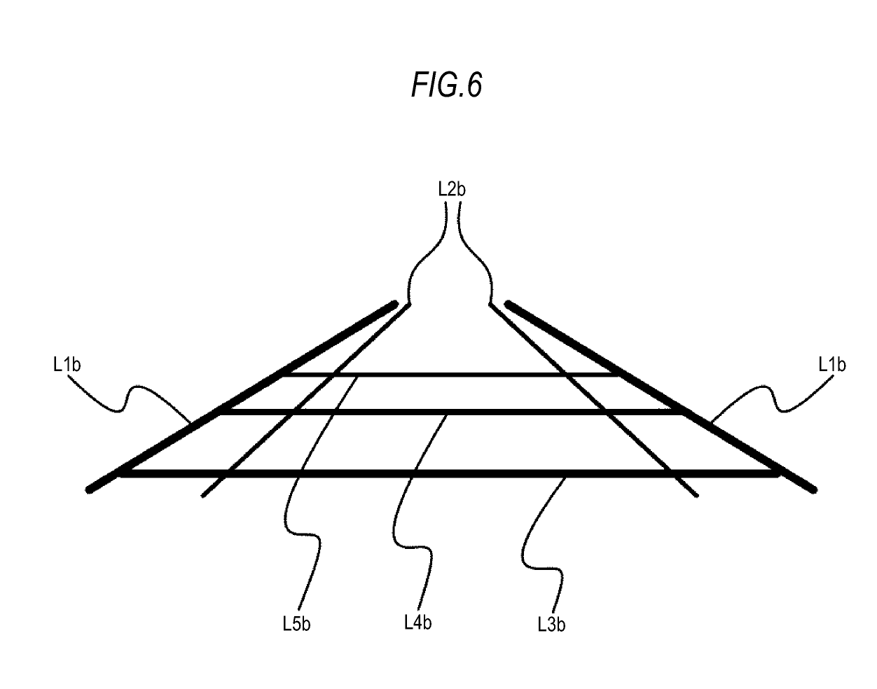

In a case where the display condition information exhibits the second display condition, of the components forming the guide line calculation portion 13 shown in FIG. 2, the lens distortion function computation portion 132, the projection function computation portion 133, and the point-of-view transformation function computation portion 135 are not operated. More specifically, the coordinate P outputted from the guide line generation portion 131 is inputted intact into the projection plane transformation function computation portion 134. Consequently, the guide line image generated in the line drawing portion 14 is as shown in FIG. 6. FIG. 6 shows an example of the guide line image generated under the second display condition. A camera image from which a lens distortion and a distortion due to the projection method are eliminated and the guide line image having no distortion are displayed by superimposing the latter on the former. In FIG. 6, lines L1b are guide lines indicating a width of the parking stall and correspond to the line L1 of FIG. 3. Lines L2b are guide lines indicating a width of the vehicle and correspond to the line L2 of FIG. 3. Lines L3b through L5b are guide lines indicating distances from the vehicle and correspond, respectively, to the line L3 through L5 of FIG. 3. Also, of the components forming the camera image correction portion 16 shown in FIG. 4, the components other than the point-of-view transformation function computation portion 163 are operated. More specifically, the camera image outputted from the projection inverse function computation portion 162 is inputted into the image superimposing portion 17 as the corrected camera image.

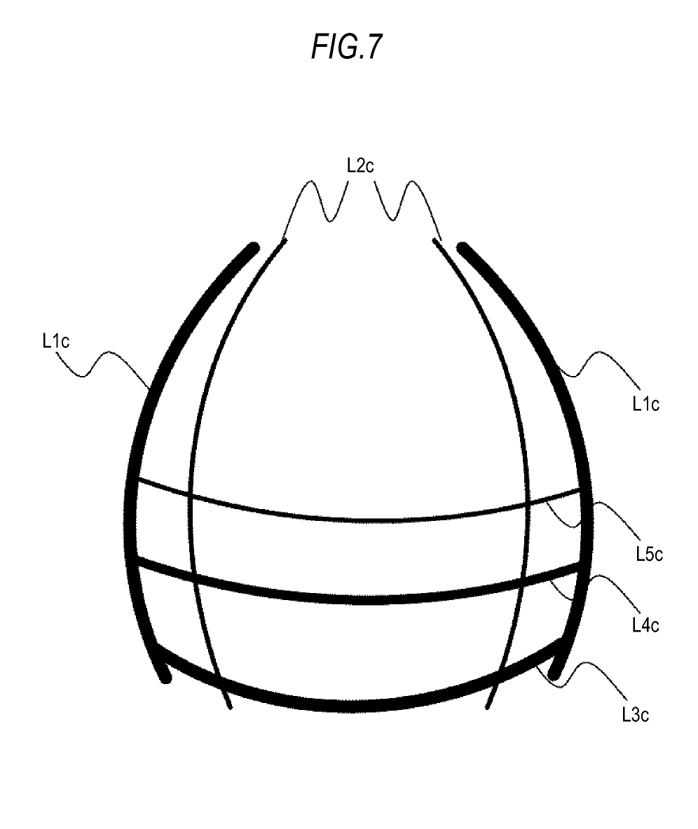

In a case where the display condition information exhibits the third display condition, all the components forming the guide line calculation portion 13 shown in FIG. 2 are operated. Consequently, the guide line image generated in the line drawing portion 14 is as shown in FIG. 7. FIG. 7 shows an example of the guide line image generated under the third display condition. A camera image having a lens distortion as if captured from a different point of view and a distortion due to the projection method and a guide line image as if viewed from the different point of view by addition of the same distortions are displayed by superimposing the latter on the former. In FIG. 7, lines L1c are guide lines indicating a width of the parking stall and correspond to the line L1 of FIG. 3. Lines L2c are guide lines indicating a width of the vehicle and correspond to the line L2 of FIG. 3. Lines L3c through L5c are guide lines indicating distances from the vehicle and correspond, respectively, to the line L3 through L5 of FIG. 3. Also, of the components forming the camera image correction portion 16 shown in FIG. 4, the point-of-view transformation function computation portion 163 alone is operated. More specifically, a camera image received in the camera image receiving portion 15 is inputted intact into the point-of-view transformation function computation portion 163. An image that has undergone the point-of-view transformation in the point-of-view transformation function computation portion 163 is outputted to the image superimposing portion 17 as the corrected camera image.

In a case where the display condition information exhibits the fourth display condition, of the components forming the guide line calculation portion 13 shown in FIG. 2, the components other than the lens distortion function computation portion 132 and the projection function computation portion 133 are operated. More specifically, the coordinate P of a point on the guide lines generated in the guide line generation portion 131 is inputted intact into the point-of-view transformation function computation portion 135. Consequently, the guide line image generated in the line drawing portion 14 is as shown in FIG. 3. Also, all the components forming the camera image correction portion 16 shown in FIG. 4 are operated. A camera image as if captured from a different point of view by elimination of a lens distortion and a distortion due to the projection method and a guide line image having no distortion as if viewed from the different point of view are displayed by superimposing the latter on the former.

As has been described, according to the parking assistance system of the first embodiment, a coordinate of guide lines calculated in the guide line calculation portion is subjected to: a transformation that gives a lens distortion due to a lens shape in the lens distortion function computation 132, the projection transformation by the projection method of the lens in the projection function computation portion 133, and the projection plane transformation in the projection plane transformation function computation portion 134 to obtain an image as if captured by the camera attached to the vehicle. Consequently, it becomes possible to display the guide line image used as a target when the driver parks the vehicle on the display portion 18 in a manner corresponding to a camera image captured by the camera of the camera unit 2.

Also, an attachment state of the camera is given as parameters: a height L of the camera attachment position with respect to the parking plane, an attachment vertical angle φ that is an angle of inclination of the optical axis of the camera with respect to a vertical line, an attachment horizontal angle φ that is an angle of inclination with respect to a center line running longitudinally from front to rear of the vehicle, and a distance H from a center of the width of the vehicle, so that the drawing positions of the guide lines are automatically calculated according to the values of the parameters. It thus becomes possible to readily generate the guide line image. For example, when a vehicle equipped with the parking assistance system of this embodiment is manufactured, the camera is fixed at the predetermined attachment position at the predetermined attachment angle both determined by design and the predetermined attachment position and angle determined by design are stored into the information storage portion 11. Owing to this configuration, it becomes possible to readily generate a guide line image corresponding to a type of the vehicle. Herein, a description has been given on the assumption that an orientation of the camera cannot be changed during the manufacturing of the vehicle equipped with the parking assistance system. However, in a case where a parking assistance system formed of a camera and a host unit is sold separately from the vehicle or the navigation apparatus, it may be configured in such a manner that, for example, the attachment vertical angle φ is changeable so that an attachment state of the camera to the vehicle can be adjusted.

Also, a size and a shape of the vehicle vary from type to type of vehicle, and so does the camera attachment position. However, according to the parking assistance system of this embodiment, by attaching the camera to the vehicle at the predetermined position and the predetermined angle both determined by design and by storing the predetermined attachment position and angle determined by design, it becomes possible to readily match a captured camera image and the guide line image. In order to eliminate influences of an attachment error, it may be configured in such a manner that an attachment error is measured to correct the attachment position and angle by the method described in Patent Document 1 or the like.

### Second Embodiment

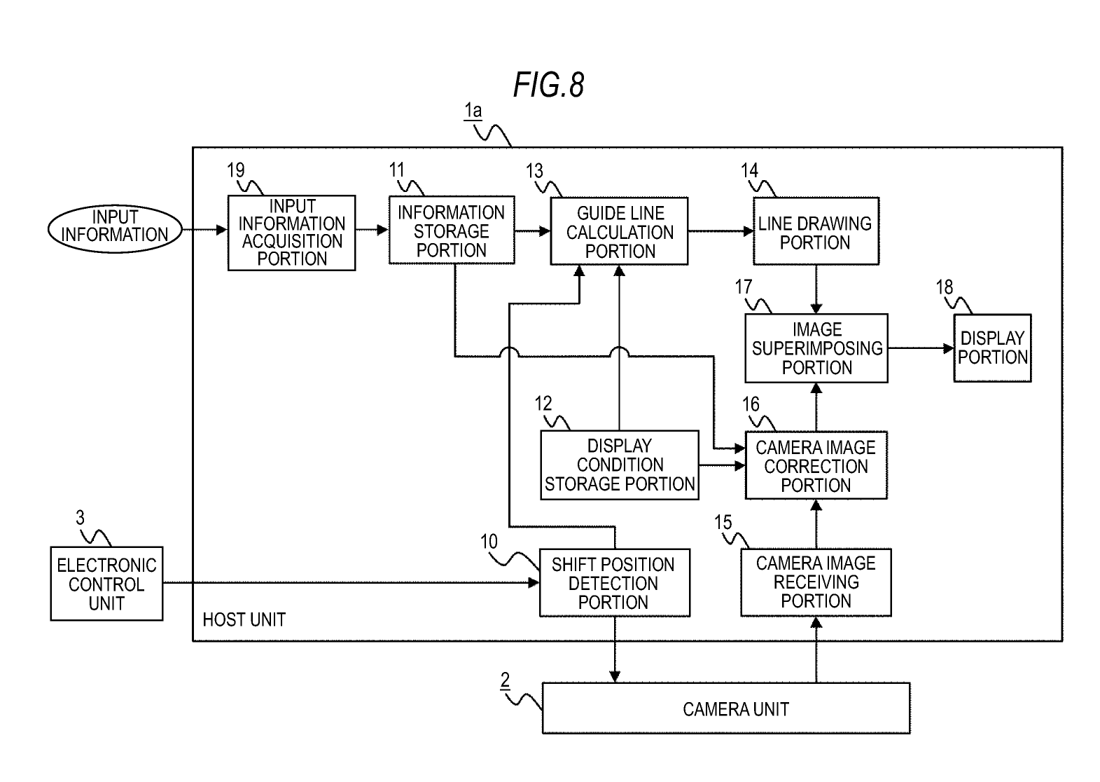

FIG. 8 is a block diagram showing a configuration of a parking assistance system of a second embodiment. In FIG. 8, components same as or corresponding to the components of FIG. 1 are labeled with the same reference numerals and a description of such components is omitted. A host unit 1a of FIG. 8 has an input information acquisition portion 19 that acquires input information from the outside. Information stored in the information storage portion 11 is changed according to the input information acquired in the input information acquisition portion 19. The input information acquisition portion 19 can be formed to have an HMI (Human Interface Interface) and the driver can input information therein by operating the HMI. Of the information stored in the information storage portion 11, a height L of the camera attachment position with respect to the parking plane, an attachment vertical angle φ that is an angle of inclination of the optical axis of the camera with respect to a vertical line, an attachment horizontal angle θ that is an angle of inclination with respect to a center line running longitudinally from front to rear of the vehicle, a distance H from a center of the width of the vehicle, a maximum horizontal field angle Xa and a maximum vertical field angle Ya of the camera, a maximum horizontal drawing pixel size Xp and a maximum vertical drawing pixel size Yp in a video output, coordinates of a subject video pattern, a projection method, and a different point of view to which point-of-view transformation is performed are parameters unique to the parking assistance system. By providing the input information acquisition portion 19, it becomes possible to change values of these parameters at an arbitrary point of time. Consequently, it becomes possible to readily address a change of the camera attachment position or a change of the camera itself of the camera unit 2.

The driver can obtain measured values of the parameters relating to an attachment state of the camera by measuring the height L of the camera attachment position and the distance H from the center of the width of the vehicle with a measure and by measuring the attachment horizontal angle θ and the attachment vertical angle φ of the camera with an angle meter. By changing the height L of the camera attachment position with respect to the parking plane, the attachment vertical angle θ that is an angle of inclination of the optical axis of the camera with respect to a vertical line, the attachment horizontal angle θ that is an angle of inclination with respect to the center line running longitudinally from front to rear of the vehicle, and the distance H from the center of the width of the vehicle stored in the information storage portion 11 to the measured values using the input information acquisition portion 19, it becomes possible to readily display guide lines corresponding to a vehicle to which the camera is attached. In a case where there is already a list of data on attachment positions on a type-by-type basis of vehicles to which the camera is attached, values set forth in the list may be inputted.

### Third Embodiment

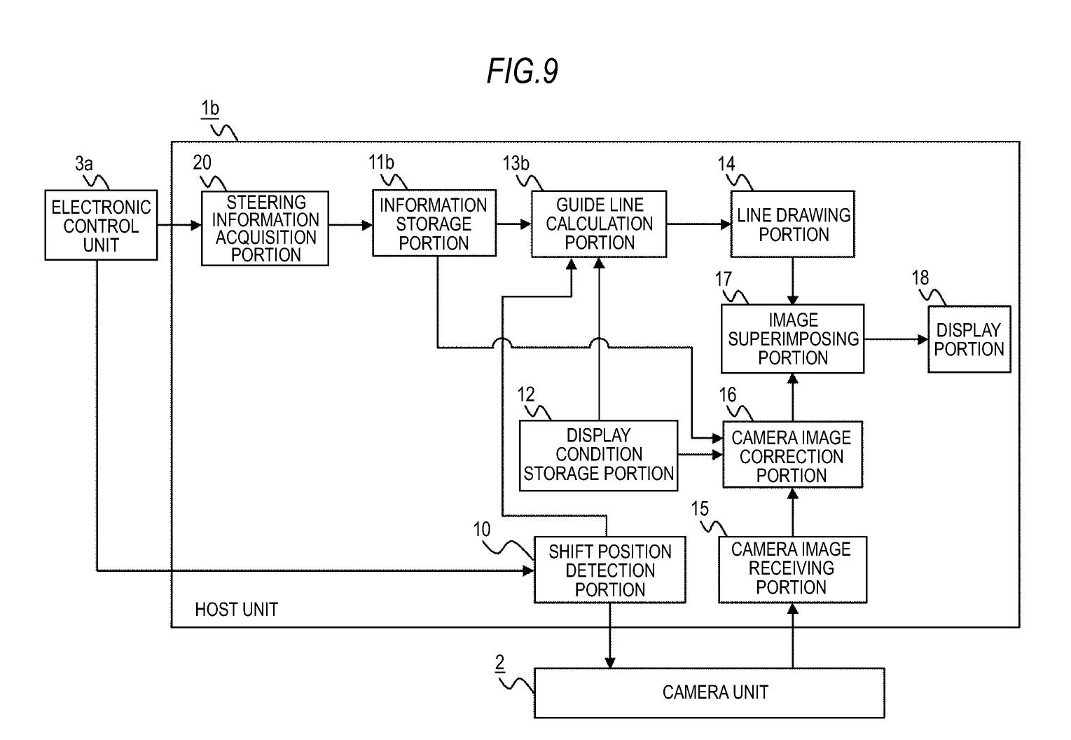

FIG. 9 is a block diagram showing a configuration of a parking assistance system of a third embodiment. In FIG. 9, a host unit 1b has a steering information acquisition portion 20 that acquires steering information of the vehicle transmitted from an outside electronic control unit 3a, and an information storage portion 11b has stored the steering information acquired by the steering information acquisition portion 20. Also, coordinates of guide lines and coordinates of running guide lines are calculated in a guide line generation portion (not shown) of a guide line computation portion 13b. It should be noted that the guide lines are set at a position when it is assumed that the vehicle is run by a predetermined distance without changing a current steering angle. The running guide lines are curves indicating estimated movement trajectory lines representing a predicted path as to what trajectory lines respective front wheels and rear wheels of the vehicle follow when the vehicle moves from the current position to the position at which the guide lines are set. By also displaying the running guide lines, the driver of the vehicle becomes able to determine whether the vehicle hits an obstacle or the like due to a difference between the trajectory lines followed by the front and rear inner or outer wheels.

By carrying out an operation, such as a lens distortion function computation, for not only the coordinates of the guide lines but also the coordinates of the running guide lines, it becomes possible to compute and draw running guide lines that can be addressed to a change of the steering information (angle) by a steering operation on the vehicle.

### Fourth Embodiment

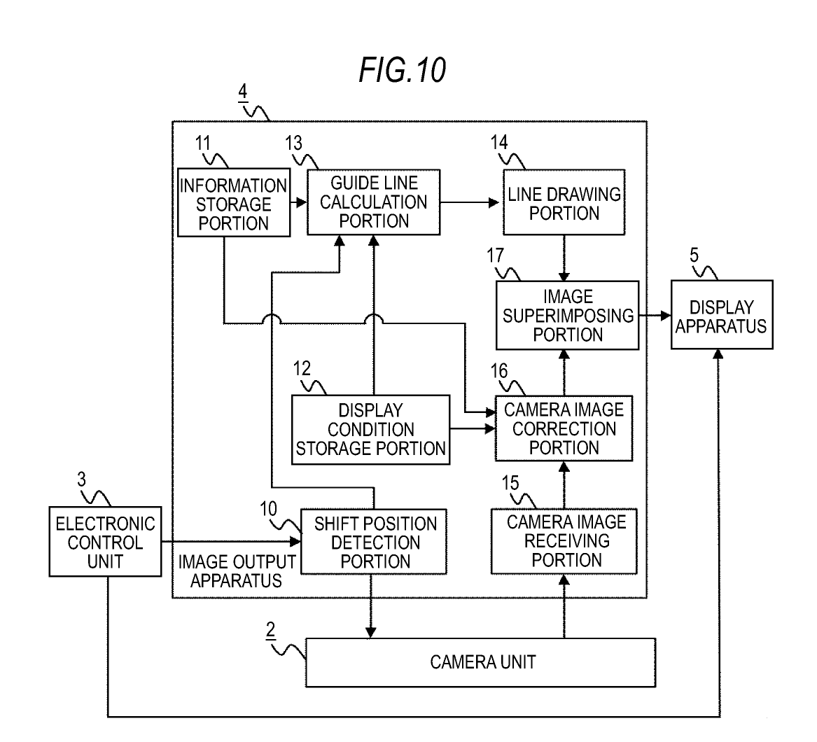

The first through third embodiments above have been described on the assumption that the host unit has the display portion. However, it may be configured in such a manner that an image output apparatus 4 that outputs a composite image on which the guide line image is superimposed and an outside display apparatus 5, for example, an in-vehicle navigation apparatus, are combined to display a composite image outputted from the image output device 4 on the display apparatus 5. In this embodiment, the image output apparatus 4 is the parking assistance apparatus. FIG. 10 is a block diagram showing a configuration of a parking assistance system of the fourth embodiment. Components same as or corresponding to the components of FIG. 1 are labeled with the same reference numerals and a description of such components is omitted. In FIG. 4, shift position information is outputted from an electronic control unit 3 to a shift position detection portion 10 and the display apparatus 5. A connection interface of the image output apparatus 4 to the electronic control unit 3 is the same as that of a typical navigation apparatus. Hence, communications are enabled between the image output apparatus 4 and the electronic control unit 3 without a need to prepare a special interface. While the shift position information informing that a transmission of the vehicle is in a reverse state is inputted into the display apparatus 5 from the electronic control unit 3, the display apparatus 5 switches to a mode in which to display an image inputted therein and therefore displays an image outputted from the image output apparatus 4. Accordingly, when the driver of the vehicle shifts a gear of the vehicle to the reverse position, a composite image is outputted from the image output apparatus 4 and the composite image is displayed on the display apparatus 5. In this manner, it becomes possible to assist the driver in parking the vehicle by displaying an image of the parking plane behind the vehicle at the time of parking.

In the above description, the display apparatus 5 is configured to display an image outputted from the image output apparatus 4 upon input of the shift position information informing that the transmission of the vehicle is in a reverse state from the electronic control unit 3. In addition to this configuration, it may be configured in such a manner that the display apparatus 5 is provided with a changeover switch that switches the display apparatus 5 to a mode in which to display an image inputted therein, so that the display apparatus 5 displays an image outputted from the image output apparatus 4 when the user presses the changeover switch.

### Fifth Embodiment

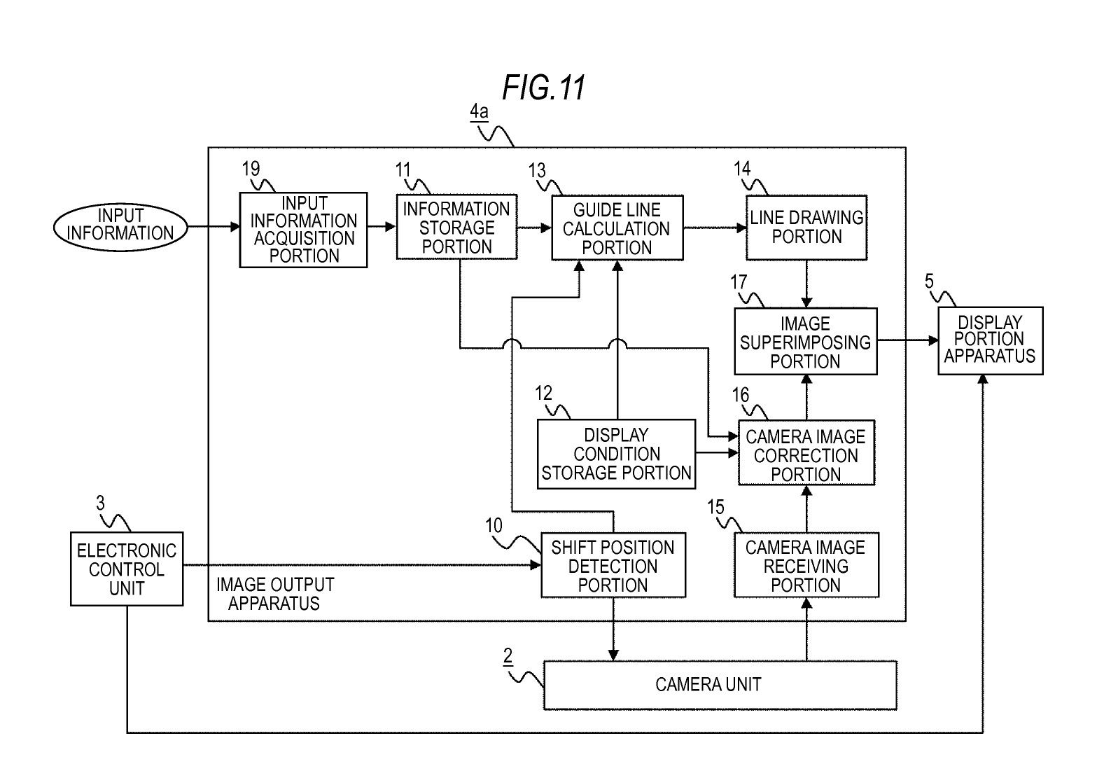

FIG. 11 is a block diagram showing a configuration of a parking assistance system of a fifth embodiment. In FIG. 11, components same as or corresponding to the components of FIG. 10 are labeled with the same reference numerals and a description of such components is omitted. An image output apparatus 4a has an input information acquisition portion 19 that acquires input information. By using the input information acquisition portion 19 provided to the image output apparatus 4a, such as a DIP switch, a dial, and a push button used to input numerical values or select values, it becomes possible to store the input information into an information storage portion 11. Different form the host unit 1 of the first and other embodiments above, the image output apparatus 4a does not have an image display portion that displays an image thereon. Hence, in a case where the driver changes information stored in the information storage portion 11, information stored in the information storage portion 11 is displayed on the display apparatus 5, so that the driver views the displayed information and determines whether a value he is going to input is stored in the information storage portion 11. In a case where the value is not stored, the driver makes a change using the input information acquisition portion 19.

### Sixth Embodiment

In the first embodiment above, a camera image and a guide line image transmitted from the camera unit are combined in the host unit. It is, however, also possible to provide components to generate a guide line image, such as an information storage portion, a guide line calculation portion, and a line drawing portion, within the camera unit. A camera unit that outputs a composite image in which the guide line image is superimposed on the camera image is referred to as a parking assistance camera unit. In the sixth embodiment, a parking assistance system is formed by combining the parking assistance camera unit and a display apparatus that displays thereon an image outputted from the parking assistance camera unit.

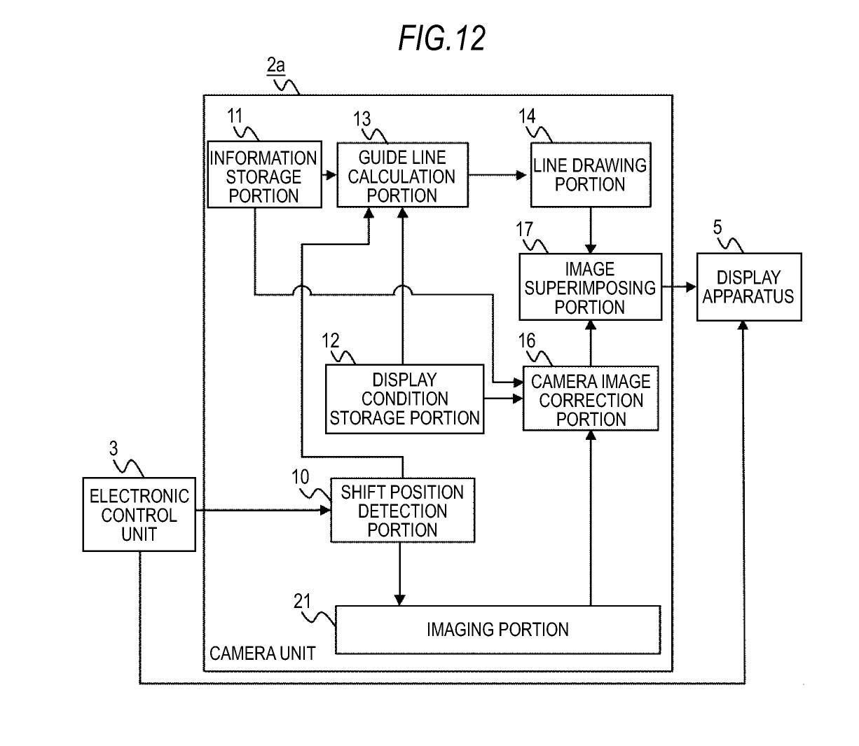

FIG. 12 is a block diagram showing a configuration of the parking assistance system of the sixth embodiment. In FIG. 12, components same as or corresponding to the components of FIG. 10 are labeled with the same reference numerals and a description of such components is omitted. An imaging portion 21 of a camera unit 2a captures an image of the parking plane behind the vehicle while the shift position information informing that a transmission of the vehicle is in a reverse state is received from a shift position detection portion 10. A camera image captured by the imaging portion 21 is outputted to a camera image correction portion 16. As in the same manner in the first and other embodiments above, the camera image correction portion 16 outputs a composite image in which the guide line image is superimposed on the camera image to the display apparatus.

As with the display apparatus 5 in the fourth embodiment above, the display apparatus of this embodiment also switches to a mode in which to display an image inputted therein while the shift position information informing that the transmission of the vehicle is in a reverse state is inputted therein from an electronic control unit 3. Hence, when the transmission of the vehicle is changed to a reverse state in response to an operation by the driver of the vehicle, an image for parking assistance is displayed on the display apparatus 5.

### Seventh Embodiment

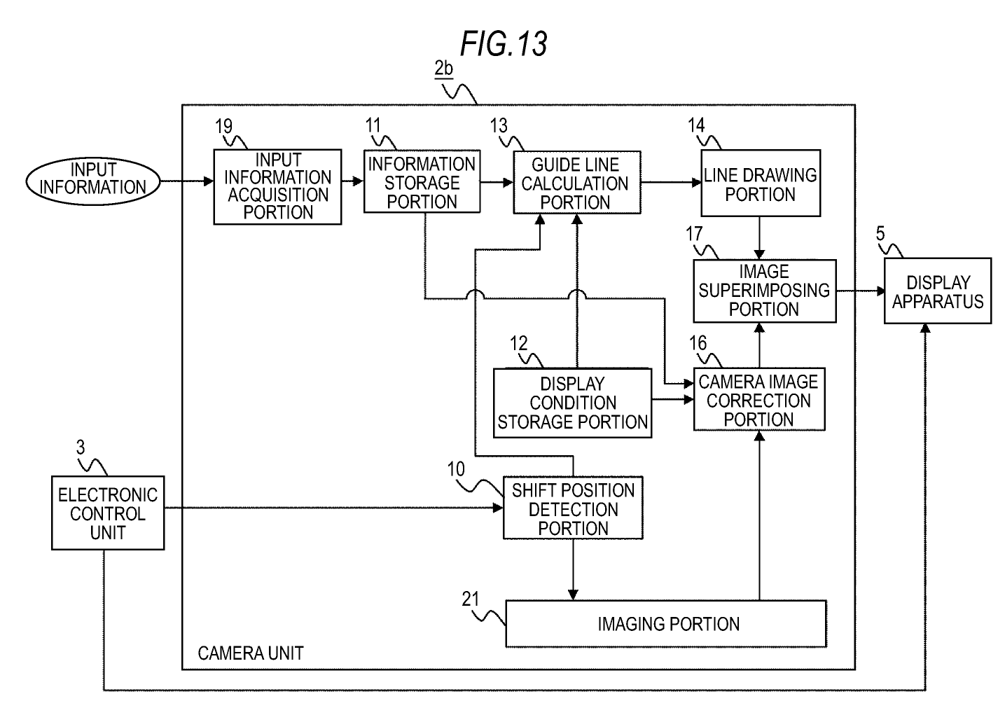

FIG. 13 is a block diagram showing a configuration of a parking assistance system of a seventh embodiment. In FIG. 13, components same as or corresponding to the components of FIG. 12 are labeled with the same reference numerals and a description of such components is omitted. A camera unit 2b further has an input information acquisition portion 19 that acquires input information and stores the input information into the information storage portion 11. The input information acquisition portion 19 is a device provided to the camera unit 2b, such as a DIP switch, a dial, and a push button used to input numerical values or select values. The driver stores input information into the information storage portion using the input information acquisition portion 19. Different from the host unit 1 of the first and other embodiments above, the camera unit 2b does not have an image display portion that displays an image thereon. Hence, in a case where the driver input information or changes information stored in the information storage portion 11, information stored in the information storage portion 11 is displayed on a display apparatus 5, so that the driver views the displayed information and determines whether a value he is going to input is stored in the information storage portion 11.

In the embodiments described above, a coordinate of a subject image pattern of the guide lines in an actual space is given by a two-dimensional value (x, y). It should be appreciated, however, that the coordinate may be given by a three-dimensional value.

It should be noted that the parking assistance systems described above can be formed, for example, of an in-vehicle navigation apparatus as the host unit and an in-vehicle camera as the camera unit.

In the parking assistance systems described above, the guide line image and the corrected camera image in different layers are inputted into the display portion and combined in the display portion. However, it may be configured in such a manner that these images are combined in the image superimposing portion and the resulting composite image is outputted to the display portion. In this case, a size of the corrected camera image is changed to a displayable size of the display portion by computing a video output function g( ) for the correction camera image and then the guide line image and the corrected camera image in the changed size are combined in the image superimposing portion.

### DESCRIPTION OF REFERENCE NUMERALS AND SIGNS

1, 1a, and 1b: host unit (parking assistance apparatus)
2: camera unit
2a and 2b: camera unit (parking assistance camera unit)
3 and 3a: electronic control unit
4 and 4a: image output apparatus (parking assistance apparatus)
5: display apparatus
11 and 11b: information storage portion
12: display condition storage portion
13 and 13b: guide line calculation portion (guide line information generation portion)
14: line drawing portion (guide line image generation portion)
15: camera image receiving portion
16: camera image correction portion (image output portion)
17: image superimposing portion (image output portion)
18: display portion
19: input information acquisition portion
20: steering information acquisition portion
21: imaging portion

1. A parking assistance apparatus connected to a camera that is attached to a vehicle and captures an image of a parking plane behind the vehicle and displaying, on a display apparatus, an image in which guide lines used as a target when the vehicle is parked are set on the parking plane on the basis of a camera image captured by the camera, comprising:
an information storage portion that stores guide line interval information on intervals among the guide lines containing parking width information, vehicle width information, and distance information indicating a distance from a rear end of the vehicle and attachment information indicating attachment position and angle of the camera with respect to the vehicle;
a guide line information generation portion that generates guide line information on positions of the guide lines set on the parking plane in the camera image on the basis of the guide line interval information and the attachment information;
a guide line image generation portion that generates a guide line image representing the guide lines on the basis of the guide line information; and
an image output portion that outputs, to the display apparatus, an image in which the guide lines are set on the parking plane on the basis of the guide line image and the camera image.

2. The parking assistance apparatus according to claim 1, wherein:
the camera is attached at a predetermined attachment position and at a predetermined attachment angle determined according to a type of the vehicle; and
the attachment information indicates the predetermined attachment position and the predetermined attachment angle.

3. The parking assistance apparatus according to claim 1, wherein:
the parking assistance apparatus is connected to a shift position information output apparatus that outputs shift position information indicating a state of a transmission of the vehicle; and
the image output portion outputs the image in which the guide lines are set on the parking plane in a case where the shift position information indicates that the transmission of the vehicle is in a reverse state.

4. The parking assistance apparatus according to claim 1, wherein:
the information storage portion has stored lens distortion information indicating a distortion of the camera image due to a lens shape of the camera and projection distortion information indicating a distortion of the camera image due to a projection method of the lens; and
the guide line information generation portion generates the guide line information on the basis of the lens distortion information and the projection distortion information.

5. The parking assistance apparatus according to claim 1, wherein:
the information storage portion has stored lens distortion information indicating a distortion of the camera image due to a lens shape of the camera and projection information indicating a distortion of the camera image due to a projection method of the lens; and
the image output portion corrects the camera image to be a camera image from which distortions due to the lens shape and the projection method are eliminated on the basis of the lens distortion information and the projection distortion information and outputs, to the display apparatus, the image in which the guide lines are set on the parking plane on the basis of the corrected camera image and the guide line image.

6. The parking assistance apparatus according to claim 1, wherein:
the information storage portion has stored lens distortion information indicating a distortion of the camera image due to a lens shape of the camera, projection information indicating a distortion of the camera image due to a projection method of the lens, and point-of-view information indicating a position and an orientation of a point of view present at a different position from a position of the camera;
the guide line information generation portion generates the guide line information on the basis of the lens distortion information, the projection distortion information, and the point-of-view information; and
the image output portion corrects the camera image to be a camera image as if captured from the point of view on the basis of the point-of-view information and outputs, to the display apparatus, the image in which the guide lines are set on the parking plane on the basis of the corrected camera image and the guide line image.

7. The parking assistance apparatus according to claim 1, wherein:
the information storage portion has stored lens distortion information indicating a distortion of the camera image due to a lens shape of the camera, projection information indicating a distortion of the camera image due to a projection method of the lens, and point-of-view information indicating a position and an orientation of a point of view present at a different position from a position of the camera;
the guide line information generation portion generates the guide line information on the basis of the point-of-view information; and
the image output portion corrects the camera image to be a camera image captured from the point of view and from which distortions due to the lens shape and the projection method are eliminated on the basis of the lens distortion information, the projection distortion information, and the point-of-view information, and outputs, to the display apparatus, the image in which the guide lines are set on the parking plane on the basis of the corrected camera image and the guide line image.

8. The parking assistance apparatus according to any one of claims 1 through 7, further comprising:
an information changing portion that changes a content of information stored in the information storage portion in response to an input from an outside.

9. A parking assistance system, comprising:
the camera that is attached to a vehicle and captures an image of a parking plane behind the vehicle; and
the parking assistance apparatuses set forth in any one of claims 1 through 7 that is connected to the camera and displays, on a display apparatus, an image in which the guide lines are set on the parking plane on the basis of a camera image captured by the camera.

10. A parking assistance camera unit that displays an image in which guide lines used as a target when a vehicle is parked are set on a parking plane behind the vehicle, comprising:
a camera that is attached to the vehicle and captures an image of the parking plane behind the vehicle;
an information storage portion that stores guide line interval information on intervals among the guide lines and attachment information indicating attachment position and angle of the camera with respect to the vehicle;
a guide line information generation portion that generates guide line information on positions of the guide lines set on the parking plane in the camera image on the basis of the guide line interval information and the attachment information;
a guide line image generation portion that generates a guide line image representing the guide lines on the basis of the guide line information; and
an image output portion that outputs, to the display apparatus, an image in which the guide lines are set on the parking plane on the basis of the guide line image and the camera image.
